(19) United States
(12) Patent Application Publication
(10) Pub. No.: US 2025/0290530 A1
(43) Pub. Date: Sep. 18, 2025

(54) AUTOMATIC FASTENING DEVICE USING MAGNET

(71) Applicant: Samsung Electronics Co., Ltd., Suwon-si (KR)

(72) Inventors: Yunsu CHO, Suwon-si (KR); Junghun LEE, Suwon-si (KR)

(21) Appl. No.: 19/221,122

(22) Filed: May 28, 2025

Related U.S. Application Data
(63) Continuation of application No. PCT/KR2023/017284, filed on Nov. 1, 2023.

(30) Foreign Application Priority Data
Nov. 29, 2022 (KR) 10-2022-0162187
Dec. 14, 2022 (KR) 10-2022-0175002

(51) Int. Cl. F16B 1/00

(52) U.S. Cl. CPC F16B 1/00; F16B 2200/83

(57) ABSTRACT

A fastening structure may comprise: a first case including a first plane portion and a first protrusion portion of which the central area protrudes downward from the first plane portion, and formed to rotate with reference to the central axis; a ring-shaped second case formed so that at least a portion of the first protrusion portion extends therethrough, and including at least one groove recessed in an outward direction in the inner portion thereof; and a base including a second plane portion and a second protrusion portion which protrudes upward from the second plane portion and corresponds to a first concave portion formed by the first case and the second case. The first protrusion portion may include a plurality of first magnets. The second plane portion of the base may include a plurality of second magnets arranged to be capable of vertically corresponding to the plurality of first magnets. The second protrusion portion of the base may include a third magnet disposed to be able to face horizontally with at least one magnet of the plurality of first magnets and to be able to face horizontally with the groove.

### CROSS-REFERENCE TO RELATED APPLICATIONS

This application is a continuation of International Application No. PCT/KR2023/017284, designating the United States, filed on Nov. 1, 2023, in the Korean Intellectual Property Receiving Office and claiming priority to Korean Patent Application Nos. 10-2022-0162187, filed on Nov. 29, 2022, and 10-2022-0175002, filed on Dec. 14, 2022, in the Korean Intellectual Property Office, the disclosures of each of which are incorporated by reference herein in their entireties.

### BACKGROUND

### Field

The disclosure relates to an automatic fastening device using a magnet.

### Description of Related Art

Due to advancement in information and communication technology and semiconductor technology, various functions are being integrated into a single portable electronic device. For example, an electronic device may implement not only communication functions, but also entertainment functions such as gaming, multimedia functions such as music/video playback, communication and security functions for mobile banking and the like, and functions for schedule management and an electronic wallet function. With the development of electronic and communication technologies, such electronic devices are becoming more compact and lightweight to the extent that they can be used without any inconvenience while being worn on a user's body.

### SUMMARY

A fastening structure according to an example embodiment of the disclosure may include: a first case configured to rotate about a central axis and including a first planar portion and a first protrusion protruding downward from a central area of the first planar portion, a ring-shaped second case configured to allow at least a portion of the first protrusion to pass therethrough and including at least one groove recessed in an inner portion and, and a base including a second planar portion, and a second protrusion protruding upward from the second planar portion and corresponding to a first concave portion defined by the first case and the second case. The first protrusion may include multiple first magnets. The second planar portion of the base may include multiple second magnets disposed to vertically correspond to the multiple first magnets. The second protrusion of the base may include a third magnet disposed to horizontally face at least one of the multiple first magnets and to horizontally face the first groove.

A fastening structure according to an example embodiment of the disclosure may include: a first case configured to rotate about a central axis and including a first planar portion and a first protrusion protruding downward from a central area of the first planar portion, a ring-shaped second case configured to allow at least a portion of the first protrusion to pass therethrough and including at least one groove recessed in an inner portion, and a base including a second planar portion, and a second protrusion protruding upward from the second planar portion and corresponding to a first concave portion defined by the first case and the second case. The first protrusion may include a first magnetic assembly including a first first magnet having a first pole, and a second first magnet disposed adjacent to the first first magnet and having a second pole that is opposite to the first pole. The planar portion of the base may include a second magnetic assembly disposed to vertically correspond to the first magnetic assembly and including a first second magnet having the first pole and a second second magnet disposed adjacent to the first second magnet and having the second pole. The second protrusion of the base may include a third magnet having the first pole and disposed to horizontally face at least one magnet of the first magnetic assembly and to horizontally face the groove.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1 and 2 are perspective views illustrating a fastening structure of a fastening device according to various embodiments;

FIG. 3 is an exploded perspective view of the fastening structure according to various embodiments;

FIG. 4A is a diagram illustrating a top projection view of a first case according to various embodiments;

FIG. 4B is a cross-sectional side view of the first case of FIG. 4A, taken along line B-B′ according to various embodiments;

FIG. 5A is a perspective view illustrating a second case according to various embodiments;

FIG. 5B is a cross-sectional side view of the second case of FIG. 5A, taken along line B-B′ according to various embodiments;

FIG. 6A is a diagram illustrating a top projection view of a base according to various embodiments;

FIG. 6B is a cross-sectional side view of the base of FIG. 6A, taken along line B-B′ according to various embodiments;

FIG. 7 is a perspective cross-sectional view illustrating a fastening structure before coupling according to various embodiments;

FIGS. 8A and 8B are diagrams illustrating a coupled and fixed state of the fastening structure according to various embodiments;

FIGS. 9A and 9B are cross-sectional views illustrating an uncoupled state of the fastening structure according to various embodiments;

FIG. 10 is a perspective view illustrating a guide portion that guides the coupling position of a second case and a base according to various embodiments;

FIG. 11 is a diagram illustrating a top projection view of a fastening structure according to various embodiments;

FIG. 12 is an exploded perspective view illustrating the magnets of the fastening structure according to various embodiments;

FIG. 13 is a diagram illustrating a top projection view of the first case according to various embodiments;

FIG. 14 is a diagram illustrating a top projection view of the base according to various embodiments;

FIG. 15 is a cross-sectional view illustrating a pre-coupling state of the fastening structure according to various embodiments;

FIGS. 16A and 16B are diagrams illustrating the coupled and fixed state of the fastening structure according to various embodiments; and

FIGS. 17A and 17B are diagrams illustrating an uncoupled state of the fastening structure according to various embodiments.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

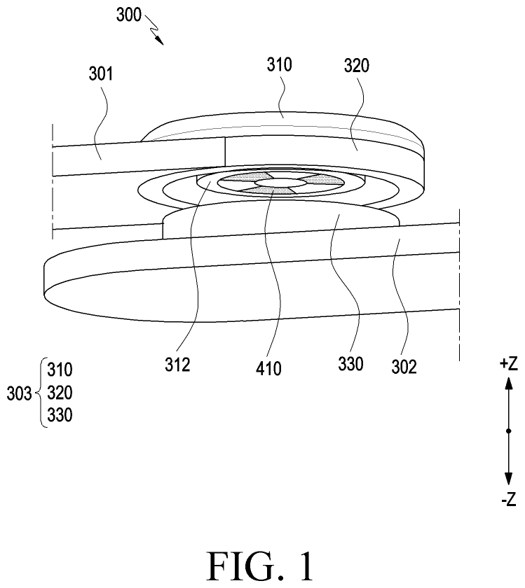

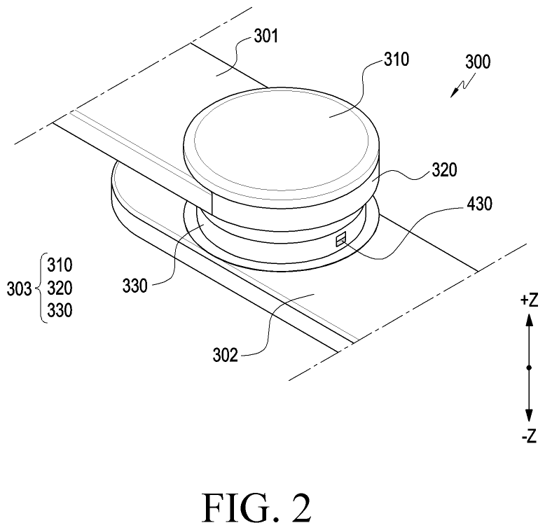

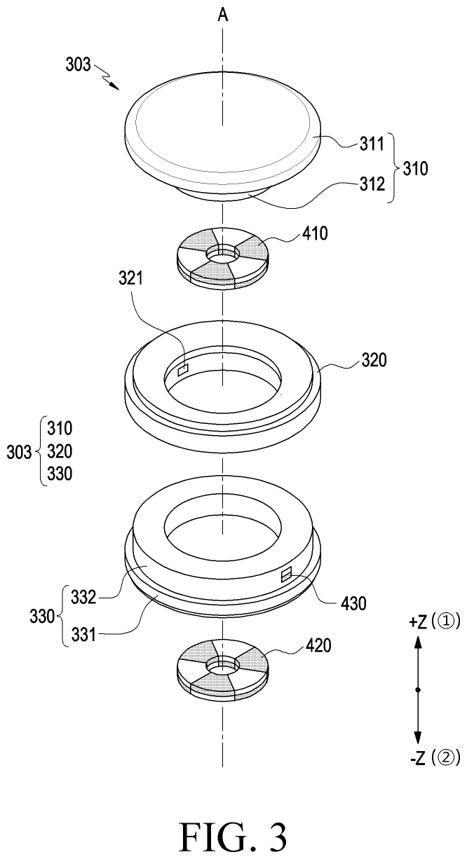

FIGS. 1 and 2 are perspective views illustrating a fastening structure 303 of a fastening device 300 according to various embodiments. FIG. 3 is an exploded perspective view of the fastening structure 303 according to various embodiments.

According to an embodiment, the fastening device 300 may include a first body 301, a second body 302, and a fastening structure 303 configured to couple and/or fix the first body 301 and the second body 302. The fastening device 300 may detachably couple the first body 301 and the second body 302 using the fastening structure 303. According to an embodiment, the first body 301 and the second body 302 may be coupled and/or fixed by a user and may be separated by releasing the coupling. In the disclosure, the fastening device 300 may include any device capable of detachably coupling two or more components. For example, the fastening device 300 may be a device requiring fastening of two or more components, such as a strap of a wearable electronic device, a mount portion of a vehicle holder, or a fan. In the disclosure, the first body 301 and the second body 302 are comprehensive concepts that may refer to not only elements of specific components, such as a shaft, a plate, or a block, but also the specific components themselves.

According to an embodiment, the fastening structure 303 may include a first case 310 attached to the first body 301, a second case 320 coupled to the first case 310, and a base 330 attached to the second body 302. Upon the coupling and/or separation of a combination of the first case 310 and the second case 320 (hereinafter referred to as a “case”) and a base 330, the first body 301 and the second body 302 may be coupled and/or separated.

According to an embodiment, the fastening structure 303 may be a structure using magnets. For example, the fastening structure 303 may couple the first body 301 and the second body 302 using the attraction of magnets. For example, the fastening structure 303 may separate the first body 301 and the second body 302 using the repulsion of magnets. According to an embodiment, the fastening structure 303 may have a structure in which multiple magnets are coupled in a complex manner. Hereinafter, the fastening structure 303 will be described in detail.

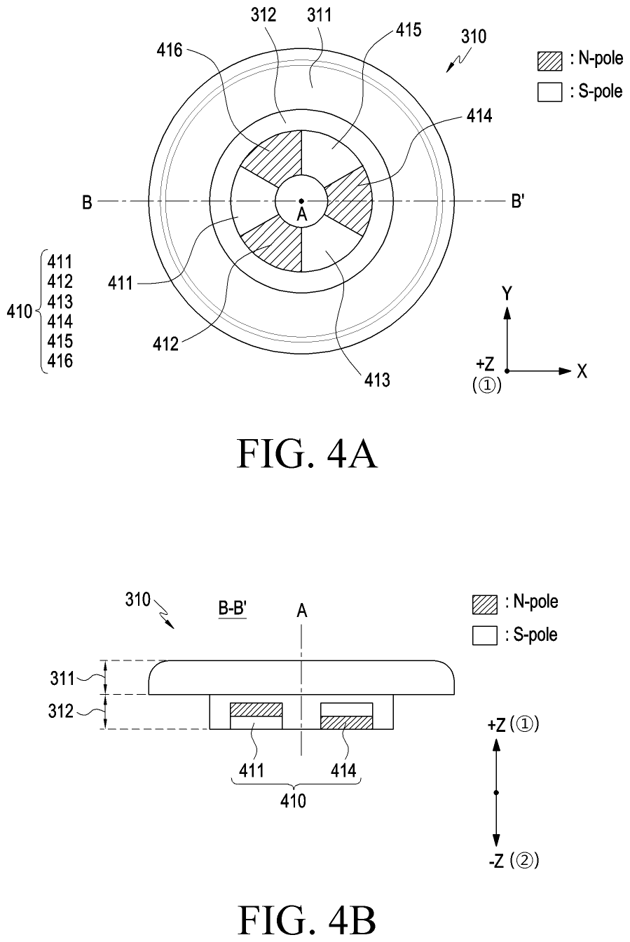

FIG. 4A is a diagram illustrating a top projection view of the first case 310 according to various embodiments. FIG. 4B is a cross-sectional side view of the first case 310 of FIG. 4A, taken along line B-B′ according to various embodiments.

Referring to FIGS. 4A and 4B, the fastening structure 303 may include a first case 310 attached to the first body 301, a second case 320 coupled to the first case 310, and a base 330 attached to the second body 302. According to an embodiment, the fastening structure 303 may include multiple first magnets 410 disposed in a first protrusion 312 of the first case 310, multiple second magnets 420 disposed in a second planar portion 331 of the base 330, and a third magnet 430 disposed in a second protrusion 332 of the base 330. The configurations of the first case 310, the second case 320, the base 330, the multiple first magnets 410, the multiple second magnets 420, and the third magnet 430 in FIGS. 4A and 4B may be wholly or partially the same as the configurations of the first case 310, the second case 320, the base 330, the multiple first magnets 410, the multiple second magnets 420, and the third magnet 430 in FIGS. 1, 2 and 3 (which may be referred to as FIGS. 1 to 3). The structures in FIGS. 4A and 4B may be selectively combined with the structures in FIGS. 1 to 3.

According to an embodiment, the first case 310 may include a first planar portion 311 and a first protrusion 312 having a central area protruding downward from the first planar portion 311. The first case 310 may have a circular shape when viewed in the Z-axis direction. The first protrusion 312 may have a circular shape with the same central axis A as the first planar portion 311 and a smaller diameter than the first planar portion 311 when viewed in the Z-axis direction. According to an embodiment, the first case 310 may be configured to rotate around the central axis A. According to an embodiment, the first case 310 may be configured to engage with the second case 320 via concavo-convex structures.

According to an embodiment, the fastening structure 303 may include multiple first magnets 410 disposed in the first protrusion 312 of the first case 310.

According to an embodiment, the multiple first magnets 410 may be arranged such that magnets, of which the N-pole is oriented in a first direction \textcircled{1} (e.g., upward), and magnets, of which the N-pole is oriented in a second direction \textcircled{2} (e.g., downward), are alternately arranged. The multiple first magnets 410 may include a (1-1)^{th} magnet 411, of which the N-pole is oriented in the first direction \textcircled{1} and a (1-2)^{th} magnet 412, of which the N-pole is oriented in the second direction \textcircled{2} and which is in contact with the (1-1)^{th} magnet 411. Hereinafter, for convenience of explanation, descriptions may be based on the N-pole. In an embodiment of the disclosure, since the S-pole is oriented in a direction opposite to the N-pole, it may be understood in the same manner. For example, when the N-pole of a magnet is oriented in the first direction \textcircled{1}, the S-pole may be oriented in the second direction \textcircled{2}. For example, when the N-pole is oriented in the second direction \textcircled{2}, the S-pole may be oriented in the first direction \textcircled{1}.

According to an embodiment, the multiple first magnets 410 may include six magnets. For example, the multiple first magnets 410 may include a (1-1)^{th} magnet 411, of which the N-pole is oriented in the first direction \textcircled{1}, a (1-2)^{th} magnet 412, of which the N-pole is oriented in the second direction \textcircled{2} and which is in contact with the (1-1)^{th} magnet 411, a (1-3)^{th} magnet 413, of which the N-pole is oriented in the first direction \textcircled{1} and which is in contact with the (1-2)^{th} magnet 412, a (1-4)^{th} magnet 414, of which the N-pole is oriented in the second direction \textcircled{2} and which is in contact with the (1-3)^{th} magnet 413, a (1-5)^{th} magnet 415, of which the N-pole is oriented in the first direction \textcircled{1} and which is in contact with the (1-4)^{th} magnet 414, and a (1-6)^{th} magnet 416, of which the N-pole is oriented in the second direction \textcircled{2} and which is in contact with the (1-5)^{th} magnet 415. The multiple first magnets 410 may be arranged in a closed-loop shape (e.g., a donut shape), such that the (1-6)^{th} magnet 416 is again in contact with the (1-1)^{th} magnet 411. According to an embodiment, the (1-1)^{th} magnet 411 and the (1-4)^{th} magnet 414 may be disposed at opposite positions with respect to the central axis A. The (1-1)^{th} magnet 411 and the (1-4)^{th} magnet 414 may be positioned such that the N-poles thereof are oriented in opposite directions. The (1-2)^{th} magnet 412 and the (1-5)^{th} magnet 415 may be disposed in opposite directions with respect to the central axis A. The (1-2)^{th} magnet 412 and the (1-5)^{th} magnet 415 may be positioned such that the N-poles thereof are oriented in opposite directions. According to an embodiment, the multiple first magnets 410 may be an assembly in which multiple magnets are arranged in a donut shape. According to an embodiment, the multiple first magnets 410 may be a single magnet manufactured with alternating polarity directions. However, the number of multiple first magnets 410 is not limited and may be variously modified depending on the arrangement and structure of surrounding components.

According to an embodiment, the multiple first magnets 410 may be coupled to vertically correspond to the multiple second magnets 420 and may be coupled to horizontally correspond to the third magnet 430. The fastening structure 303 may have a structure that includes magnets coupled in both the horizontal and vertical directions to provide a strong coupling force, and to allow the magnets coupled in the horizontal direction and the magnets coupled in the vertical direction to be simultaneously coupled and uncoupled.

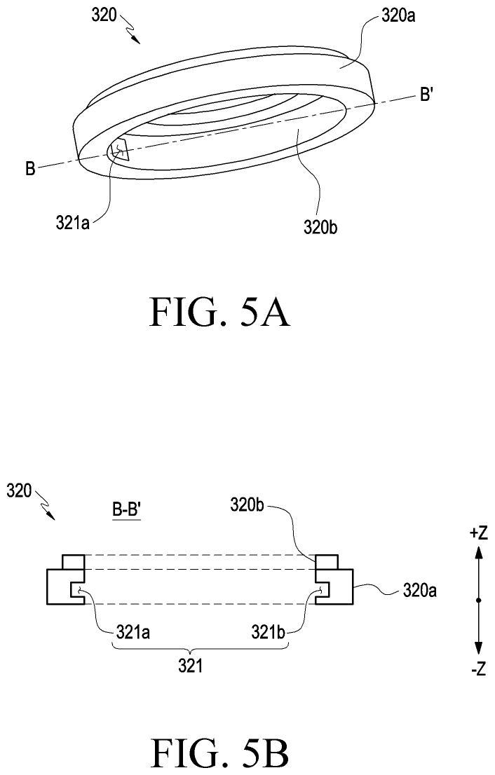

FIG. 5A is a perspective view illustrating the second case 320 according to various embodiments. FIG. 5B is a cross-sectional side view of the second case 320 of FIG. 5A, taken along line B-B′ according to various embodiments.

Referring to FIGS. 5A and 5B, the fastening structure 303 may include a first case 310 attached to the first body 301, a second case 320 coupled to the first case 310, and a base 330 attached to the second body 302. According to an embodiment, the fastening structure 303 may include multiple first magnets 410 disposed in a first protrusion 312 of the first case 310, multiple second magnets 420 disposed in a second planar portion 331 of the base 330, and a third magnet 430 disposed in a second protrusion 332 of the base 330. The configurations of the first case 310, the second case 320, the base 330, the multiple first magnets 410, the multiple second magnets 420, and the third magnet 430 in FIGS. 5A and 5B may be wholly or partially the same as the configurations of the first case 310, the second case 320, the base 330, the multiple first magnets 410, the multiple second magnets 420, and the third magnet 430 in FIGS. 1 to 4B. The structures in FIGS. 5A and 5B may be selectively combined with the structures in FIGS. 4A and 4B.

According to an embodiment, the second case 320 may be configured to allow at least a portion of the first protrusion 312 of the first case 310 to pass therethrough. The second case 320 may have a ring shape with a central portion perforated to allow the first protrusion 312 to pass therethrough. The second case 320 may be coupled to the first case 310 via concavo-convex structures and may be configured to rotate together with the first case 310. According to an embodiment, the second case 320 may include an outer portion 320a exposed to the outside and an inner portion 320b opposite to the outer portion 320a and oriented along the central axis A. The inner portion 320b may be coupled to face a side surface of the first protrusion 312.

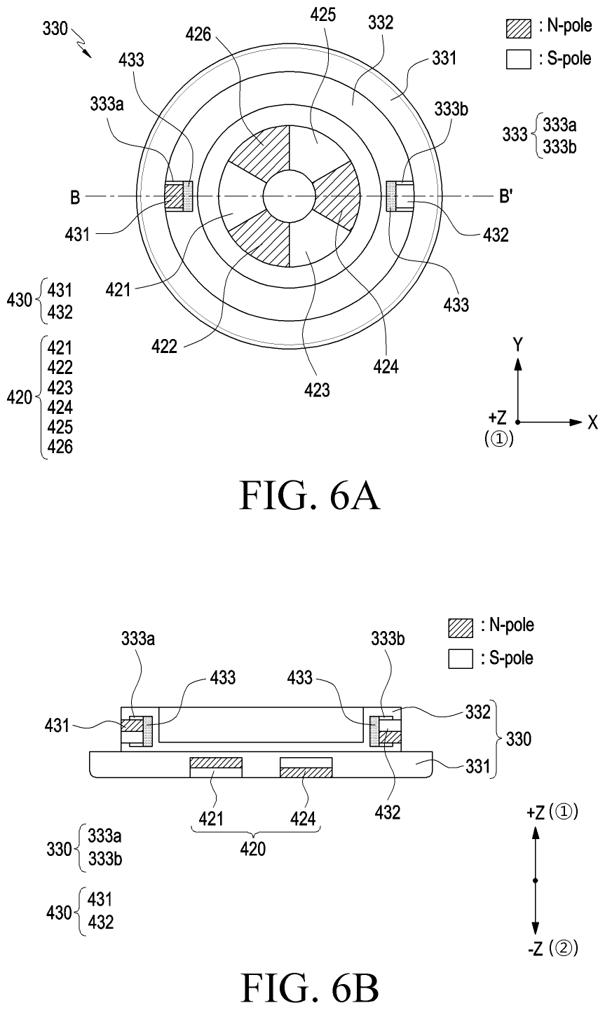

According to an embodiment, the inner portion 320b of the second case 320 may include at least one first groove 321 recessed outward. The first groove 321 may be a space in which a third magnet 430, which will be described in greater detail below, slides by magnetic force. The recessed length of the first groove 321 may be smaller than the length of the third magnet (e.g., the third magnet 430 in FIG. 6A) to be described in greater detail below. According to an embodiment, the first groove 321 of the second case 320 may include a (1-1)^{th} groove 321a and a (1-2)^{th} groove 321b disposed to face each other in opposite directions with respect to the central axis A. However, the number of grooves is not limited and may be variously modified depending on the arrangement and structure of surrounding components.

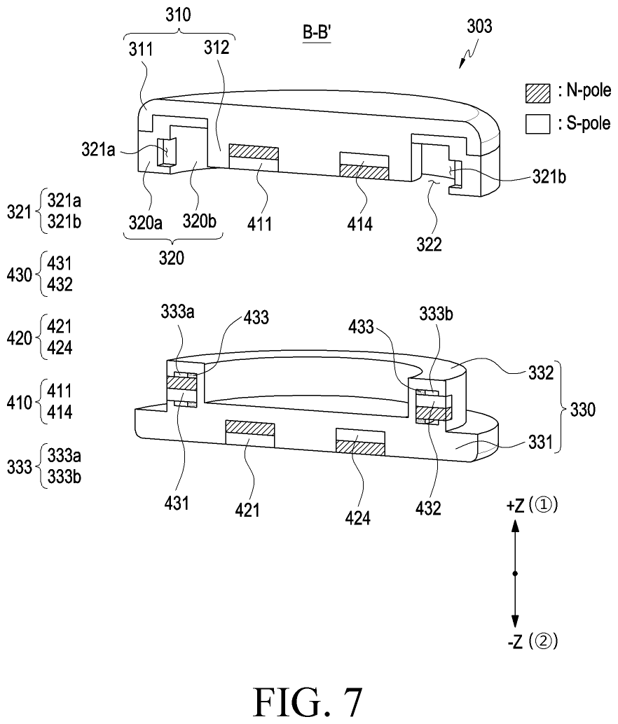

According to an embodiment, when the first case 310 and the second case 320 are coupled, the first protrusion 312 of the first case 310 and the inner portion 320b of the second case 320 may be spaced apart from each other by a predetermined interval. A first concave portion (e.g., 322 in FIG. 7) may be defined by the space between the first protrusion 312 and the inner portion 320b. A second protrusion (e.g., 332 in FIG. 6A) of a base (e.g., 330 in FIG. 6A), which will be described in greater detail below, may be inserted into and coupled to the first concave portion 322.

FIG. 6A is a diagram illustrating a top projection view of the base 330 according to various embodiments. FIG. 6B is a cross-sectional side view of the base 330 of FIG. 6A, taken along line B-B′ according to various embodiments.

Referring to FIGS. 6A and 6B, the fastening structure 303 may include a first case 310 attached to the first body 301, a second case 320 coupled to the first case 310, and a base 330 attached to the second body 302. According to an embodiment, the fastening structure 303 may include multiple first magnets 410 disposed in a first protrusion 312 of the first case 310, multiple second magnets 420 disposed in a second planar portion 331 of the base 330, and a third magnet 430 disposed in a second protrusion 332 of the base 330. The configurations of the first case 310, the second case 320, the base 330, the multiple first magnets 410, the multiple second magnets 420, and the third magnet 430 in FIGS. 6A and 6B may be wholly or partially the same as the configurations of the first case 310, the second case 320, the base 330, the multiple first magnets 410, the multiple second magnets 420, and the third magnet 430 in FIGS. 1 to 5B. The structures in FIGS. 6A and 6B may be selectively combined with the structures in FIGS. 5A and 5B.

According to an embodiment, the base 330 may be attached to a second body (e.g., the second body 302 in FIG. 1) and may be fixed in place without movement. According to an embodiment, the base 330 may include a second planar portion 331 and a second protrusion 332 protruding upward (in the +Z direction) from the second planar portion 331. The shape of the second protrusion 332 may correspond to the shape of the first concave portion 322 defined by the first case 310 and the second case 320. The base 330 may have a circular shape when viewed in the Z-axis direction. The second protrusion 332 may have a ring shape with the same central axis A as the second planar portion 331 and a smaller diameter than the second planar portion 331 when viewed in the Z-axis direction. The second protrusion 332 of the base 330 may engage with the first concave portion 322 to couple and/or fix the first body 301 and the second body 302.

According to an embodiment, the second protrusion 332 of the base 330 may include at least one second groove 333 recessed inward. A third magnet 430 may be disposed inside the second groove 333. The recessed length of the second groove 333 may be substantially the same as the length of the third magnet 430 to be described in greater detail below. According to an embodiment, the second groove 333 may include a (2-1)^{th} groove 333a and a (2-2)^{th} groove 333b disposed to face each other in opposite directions with respect to the central axis A. However, the number of grooves is not limited and may be variously modified depending on the arrangement and structure of surrounding components. According to an embodiment, the second grooves 333 may correspond to the first grooves 321 of the aforementioned second case 320. When the case and the base 330 are coupled, the case and the base 330 may be coupled such that the second groove 333 and the first groove 321 face each other. For example, the case and the base 330 may be coupled such that the (1-1)^{th} groove 321a of the second case 320 faces the (2-1)^{th} groove 333a of the base 330, and the (1-2)^{th} groove 321b of the second case 320 faces the (2-2)^{th} groove 333b of the base 330.

According to an embodiment, the fastening structure 303 may include multiple second magnets 420 disposed in the second planar portion 331 of the base 330 and a third magnet 430 disposed in the second protrusion 332 of the base 330.

According to an embodiment, the multiple second magnets 420 may correspond in shape and/or structure to the multiple first magnets 410. According to an embodiment, the multiple second magnets 420 may be arranged such that magnets, of which the N-pole is oriented in the first direction \textcircled{1} (e.g., upward), and magnets, of which the N-pole is oriented in the second direction \textcircled{2} (e.g., downward), are alternately arranged. The multiple second magnets 420 may include a (2-1)^{th} magnet 421, of which the N-pole is oriented in the first direction \textcircled{1} and a (2-2)^{th} magnet 422, of which the N-pole is oriented in the second direction \textcircled{2} and which is in contact with the (2-1)^{th} magnet 421. Hereinafter, for convenience of explanation, descriptions may be based on the N-pole. In an embodiment of the disclosure, since the S-pole is oriented in a direction opposite to the N-pole, it may be understood in the same manner. For example, when the N-pole of a magnet is oriented in the first direction \textcircled{1}, the S-pole may be oriented in the second direction \textcircled{2}. For example, when the N-pole is oriented in the second direction \textcircled{2}, the S-pole may be oriented in the first direction \textcircled{1}.

According to an embodiment, the multiple second magnets 420 may include six magnets. For example, the multiple second magnets 420 may include a (2-1)^{th} magnet 421, of which the N-pole is oriented in the first direction \textcircled{1} (e.g., upward), a (2-2)^{th} magnet 422, of which the N-pole is oriented in the second direction \textcircled{2} (e.g., downward) and which is in contact with the (2-1)^{th} magnet 421, a (2-3)^{th} magnet 423, of which the N-pole is oriented in the first direction \textcircled{1} and which is in contact with the (2-2)^{th} magnet 422, a (2-4)^{th} magnet 424, of which the N-pole is oriented in the second direction \textcircled{2} and which is in contact with the (2-3)^{th} magnet 423, a (2-5)^{th} magnet 425, of which the N-pole is oriented in the first direction \textcircled{1} and which is in contact with the (2-4)^{th} magnet 424, and a (2-6)^{th} magnet 426, of which the N-pole is oriented in the second direction \textcircled{2} and which is in contact with the (2-5)^{th} magnet 425. The multiple second magnets 420 may be arranged in a donut shape, such that the (2-6)^{th} magnet 426 is again in contact with the (2-1)^{th} magnet 421. According to an embodiment, the (2-1)^{th} magnet 421 and the (2-4)^{th} magnet 424 may be disposed in opposite positions with respect to the central axis A. The (2-1)^{th} magnet 421 and the (2-4)^{th} magnet 424 may be positioned such that the N-poles thereof face opposite directions. The (2-2)^{th} magnet 422 and the (2-5)^{th} magnet 425 may be disposed in opposite directions with respect to the central axis A. The (2-2)^{th} magnet 422 and the (2-5)^{th} magnet 425 may be positioned such that the N-poles thereof are oriented in opposite directions. According to an embodiment, the multiple second magnets 420 may be an assembly in which multiple magnets are arranged in a donut shape. According to an embodiment, the multiple second magnets 420 may be a single magnet manufactured with alternating polarity directions. However, the number of multiple second magnets 420 is not limited and may be variously modified depending on the arrangement and structure of surrounding components.

According to an embodiment, the multiple second magnets 420 may be coupled to vertically correspond to the multiple first magnets 410. According to an embodiment, the multiple second magnets 420 may guide the coupling with the multiple first magnets 410 to facilitate fastening and may provide the coupling force itself. For example, attraction between the multiple second magnets 420 and the multiple first magnets 410 may act to facilitate the coupling of the case and the base 330. For example, repulsion between the multiple second magnets 420 and the multiple first magnets 410 may act to facilitate the separation of the case and the base 330.

According to an embodiment, the third magnet 430 may be disposed in the second protrusion 332 of the base 330.

According to an embodiment, the third magnet 430 may be disposed to horizontally face at least one of the multiple first magnets 410. When the case and the base 330 are coupled, the second protrusion 332 of the base 330 may face the first protrusion 312 of the first case 310. When the case and the base 330 are coupled, the heights of the second protrusion 332 of the base 330 and the first protrusion 312 of the first case 310 (in the Z-axis direction) may be substantially the same. The heights of the third magnet 430 (in the Z-axis direction) disposed in the second protrusion 332 and the multiple first magnets 410 (in the Z-axis direction) disposed in the first protrusion 312 may substantially correspond to each other.

According to an embodiment, the third magnet 430 may be disposed to horizontally face the first groove 321 formed in the inner portion 320b of the second case 320. According to an embodiment, the third magnet 430 may be provided on the second protrusion 332 of the base 330 and may be disposed inside a second groove 333 that faces the first groove 321.

According to an embodiment, the third magnet 430 may be arranged with the same polarity as a magnet adjacent thereto among the multiple second magnets 420. For example, when the third magnet 430 is disposed adjacent to the (2-1)^{th} magnet 421, of which the N-pole is oriented in the first direction \textcircled{1} (e.g., upward), the third magnet 430 may also be disposed such that the N-pole thereof is oriented in the first direction \textcircled{1} (e.g., upward).

According to an embodiment, the third magnet 430 may include multiple magnets. According to an embodiment, the third magnet 430 may include two magnets. For example, the third magnet 430 may include a (3-1)^{th} magnet 431 and a (3-2)^{th} magnet 432 disposed in opposite directions with respect to the central axis A. For example, the (3-1)^{th} magnet 431 may be disposed adjacent to the (2-1)^{th} magnet 421 and may be disposed such that the N-pole thereof is oriented in the first direction \textcircled{1} (e.g., upward) in the same manner as the (2-1)^{th} magnet 421. For example, the (3-2)^{th} magnet 432 may be disposed adjacent to the (2-4)^{th} magnet 424 and may be disposed such that the N-pole thereof is oriented in the second direction \textcircled{2} (e.g., downward) in the same manner as the (2-4)^{th} magnet 424. In this case, the (3-1)^{th} magnet 431 and the (3-2)^{th} magnet 432 may be positioned such that the N-poles thereof are oriented in opposite directions.

According to an embodiment, the third magnet 430 may be positioned on the second protrusion 332 of the base 330, but may neither be coupled to the second protrusion 332 nor fixed in position. The third magnet 430 may be positioned inside the second groove 333 of the second protrusion 332. One surface of the third magnet 430 may be exposed to the outside.

According to an embodiment, the third magnet 430 may slide within the inner space defined by the second groove 333 and/or the first groove 321 due to the attraction and/or repulsion between the third magnet 430 and an adjacent magnet among the multiple first magnets 410. When the third magnet 430 slides from the second groove 333 to the first groove 321, a portion of the third magnet 430 may be positioned in the first groove while another portion of the third magnet 430 remains in the second groove 333, thereby allowing the case and the base 330 to be coupled and/or fixed. When the third magnet 430 slides from the first groove 321 to the second groove 333, the case and the base 330 may be separated.

According to an embodiment, an attachment 433 made of plastic may be coupled to the third magnet 430. The attachment 433 may include a low-friction plastic such as acetal (POM) or polytetrafluoroethylene (PTFE). By coupling the attachment 433 to the third magnet 430, friction may be reduced, enabling smooth sliding motion. The attachment 433 may be coupled to an inner edge of the third magnet 430. The height h1 (the Z-axis direction length) of the second groove 333 may be substantially the same as the height of the third magnet 430. The height h2 (the Z-axis direction length) of the combination of the attachment 433 and the third magnet 430 may be greater than the height of the second groove 333. Accordingly, even if a portion of the third magnet 430 is positioned outside the second groove 333 after sliding from the second groove 333 to the first groove 321, the third magnet 430 may be prevented or inhibited from completely detaching from the second groove 333.

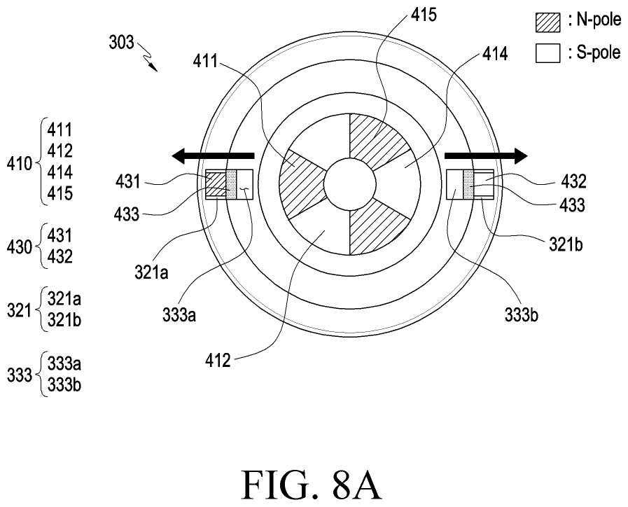

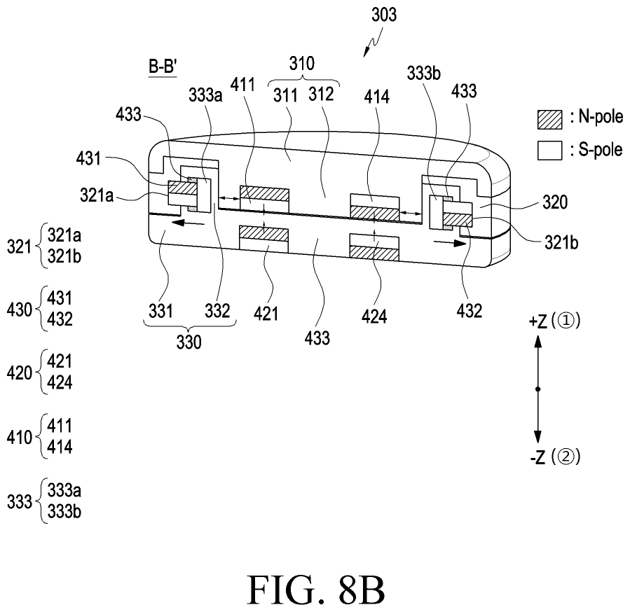

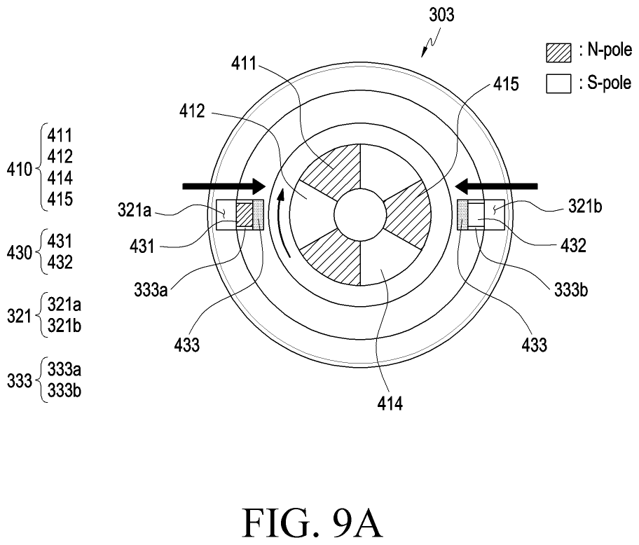

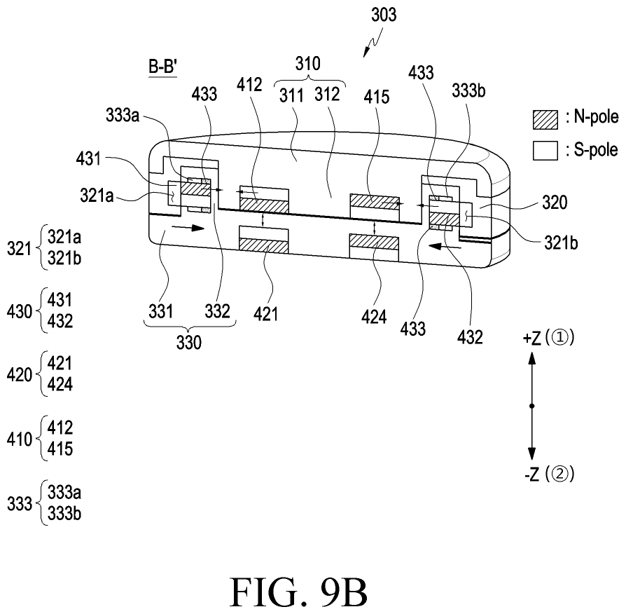

FIG. 7 is a cross-sectional perspective view illustrating a pre-coupling state of the fastening structure 303 according to various embodiments. FIGS. 8A and 8B include a diagram and a cross-sectional view illustrating a coupled and fixed state of the fastening structure 303 according to various embodiments. FIGS. 9A and 9B include a diagram and a cross-sectional view illustrating an uncoupled state of the fastening structure 303 according to various embodiments.

Referring to FIGS. 7, 8A, 8B, 9A and 9B (which may be referred to as FIGS. 7 to 9B), the fastening structure 303 may include a first case 310 attached to the first body 301, a second case 320 coupled to the first case 310, and a base 330 attached to the second body 302. According to an embodiment, the fastening structure 303 may include multiple first magnets 410 disposed in a first protrusion 312 of the first case 310, multiple second magnets 420 disposed in a second planar portion 331 of the base 330, and a third magnet 430 disposed in a second protrusion 332 of the base 330. The configurations of the first case 310, the second case 320, the base 330, the multiple first magnets 410, the multiple second magnets 420, and the third magnet 430 in FIGS. 7 to 9B may be wholly or partially the same as the configurations of the first case 310, the second case 320, the base 330, the multiple first magnets 410, the multiple second magnets 420, and the third magnet 430 in FIGS. 1 to 6B. The structures of FIGS. 7 to 9B may be selectively combined with the structures of FIGS. 6A and 6B.

According to an embodiment, referring to FIGS. 7, 8A and 8B (which may be referred to as FIGS. 7 to 8B), the process in which the case and the base 330 are coupled and fixed (locked) is described. When the case, in which the first case 310 and the second case 320 are coupled, approaches the base 330, the multiple first magnets 410 may be coupled to vertically correspond to the multiple second magnets 420, and attraction may be generated between the multiple first magnets 410 and the multiple second magnets 420. The multiple first magnets 410 may be coupled to horizontally correspond to the third magnet 430, and repulsion may be generated between the multiple first magnets 410 and the third magnet 430. The third magnet 430 may slide from the second groove 333 to the first groove 321 due to the repulsion. Since the recessed length of the first groove 321 is smaller than the length of the third magnet 430, a portion of the third magnet 430 may be disposed inside the first groove 321, while the remaining portion of the third magnet 430 may be disposed inside the second groove 333. The third magnet 430 may be disposed across the first groove 321 formed in the second case 320 and the second groove 333 formed in the base 330, thereby fixing the case and the base 330. For example, the (1-1)^{th} magnet 411, of which the N-pole is oriented in the first direction \textcircled{1}, may be coupled to vertically correspond to the (2-1)^{th} magnet 421, of which the N-pole is oriented in the first direction \textcircled{1}. In this case, since attraction is generated between the (1-1)^{th} magnet 411 and the (2-1)^{th} magnet 421, the coupling of the case and the base 330 may be facilitated. Simultaneously, the (1-1)^{th} magnet 411, of which the N-pole is oriented in the first direction \textcircled{1}, may be coupled to horizontally correspond to the (3-1)^{th} magnet 431, of which the N-pole is oriented in the first direction \textcircled{1}. In this case, since repulsion is generated between the (1-1)^{th} magnet 411 and the (3-1)^{th} magnet 431, the (1-1)^{th} magnet 411 may slide from the (2-1)^{th} groove 333a toward the (1-1)^{th} groove 321a. Since a portion of the (1-1)^{th} magnet 411 is positioned inside the (1-1)^{th} groove 321a and another portion of the (1-1)^{th} magnet 411 is positioned inside the (2-1)^{th} groove 333a, the coupling of the case and the base 330 may be fixed.

According to an embodiment, referring to FIGS. 9A and 9B, the process in which the case and the base 330 are uncoupled (unlocked) is described. A user may rotate the case clockwise or counterclockwise. When the case is rotated by a certain angle, the positions of the multiple first magnets 410 may change, thereby changing the relationship between the multiple first magnets 410 and the multiple second magnets 420, as well as the relationship between the multiple first magnets 410 and the third magnet 430. The repositioned multiple first magnets 410 may be coupled to vertically correspond to the multiple second magnets 420, and repulsion may be generated between the multiple first magnets 410 and the multiple second magnets 420. The multiple first magnets 410 may be coupled to horizontally correspond to the third magnet 430, and attraction may be generated between the multiple first magnets 410 and the third magnet 430. The third magnet 430 may slide from the first groove 321 to the second groove 333 due to the repulsion. As the third magnet 430 moves into the second groove 333, the case and the base 330 may be uncoupled. For example, when the case is rotated 60 degrees in a first rotating direction (e.g., clockwise), the (1-2)^{th} magnet 412 may be located at a position where the (1-1)^{th} magnet 411 was previously located. The (1-2)^{th} magnet 412, of which the N-pole is oriented in the second direction \textcircled{2}, may be positioned to vertically correspond to the (2-1)^{th} magnet 421, of which the N-pole is oriented in the first direction \textcircled{1}. In this case, since repulsion is generated between the (1-2)^{th} magnet 412 and the (2-1)^{th} magnet 421, the uncoupling of the case and the base 330 may be facilitated. Simultaneously, the (1-2)^{th} magnet 412, of which the N-pole is oriented in the second direction \textcircled{2}, may be positioned to horizontally correspond to the (3-1)^{th} magnet 431, of which the N-pole is oriented in the first direction \textcircled{1}. In this case, since attraction is generated between the (1-1)^{th} magnet 411 and the (3-1)^{th} magnet 431, the (1-1)^{th} magnet 411 may slide from the (1-1)^{th} groove 321a toward the (2-1)^{th} groove. After sliding, the (1-1)^{th} magnet 411 may be entirely positioned inside the (2-1)^{th} groove 333a, thereby allowing the case and the base 330 to be uncoupled. The fastening structure 303 using magnets according to an embodiment may change the magnetic force direction through rotational motion, thereby allowing the magnets doubly coupled in the horizontal and vertical directions to be simultaneously uncoupled.

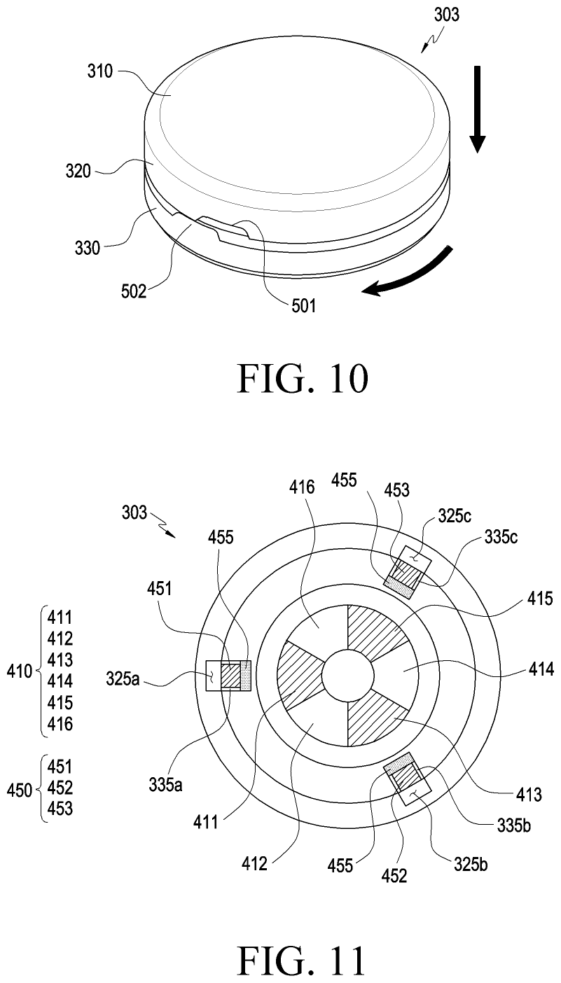

FIG. 10 is a perspective view illustrating guide portions 501 and 502 that guide the coupling position of the second case 320 and the base 330 according to various embodiments.

Referring to FIG. 10, the fastening structure 303 may include a first case 310, a second case 320 coupled to the first case 310, and a base 330. The fastening structure 303 may include multiple first magnets 410 disposed in a first protrusion 312 of the first case 310, a second magnet 440 disposed in a second planar portion 331 of the base 330, and a third magnet 430 disposed in a second protrusion 332 of the base 330. The configurations of the first case 310, the second case 320, the base 330, the multiple first magnets 410, the second magnets 440, and the third magnet 430 in FIG. 10 may be wholly or partially the same as the configurations of the first case 310, the second case 320, the base 330, the multiple first magnets 410, the multiple second magnets 420, and the third magnet 430 in FIGS. 1 to 9B. The structures in FIG. 10 may be selectively combined with the structures in FIGS. 1 to 9B.

According to an embodiment, the coupling position may be limited to allow the case and the base 330 to be coupled. The multiple first magnets 410 of the first case 310 may be coupled only in a state in which attraction acts between the multiple first magnets 410 and the multiple second magnets 420 of the base 330, and repulsion acts between the multiple first magnets 410 and the third magnet 430 simultaneously. The fastening structure 303 may further include guide portions 501 and 502 to guide and limit the coupling state to a state in which coupling and locking are facilitated. At least a portion of the side surface of the second case 320 may include a first guide portion 501 recessed upward. At least a portion of the side surface of the base 330 may protrude upward and include a second guide portion 502 corresponding to the first guide portion 501. However, the shapes of the first guide portion 501 and the second guide portion 502 are not limited, and when the first guide portion 501 and the second guide portion 502 have corresponding shapes, the first and second guide portions may be variously changed in design.

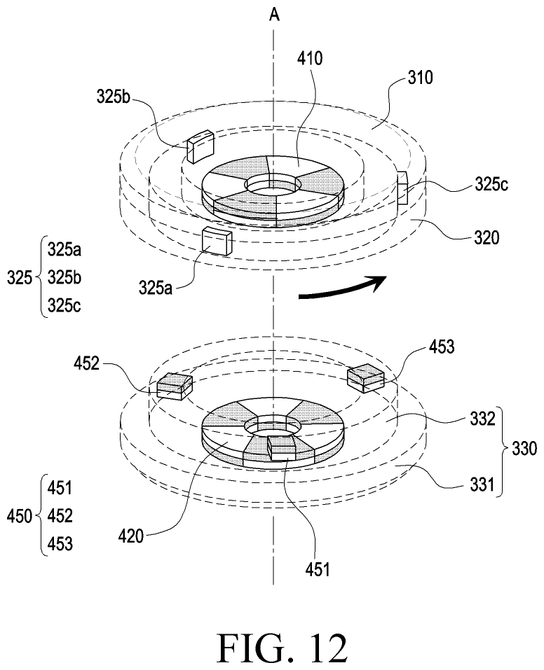

FIG. 11 is a diagram illustrating a top projection view of a fastening structure 303 according to various embodiments. FIG. 12 is an exploded perspective view illustrating magnets of the fastening structure 303 according to various embodiments.

Referring to FIGS. 11 and 12, the fastening structure 303 may include a first case 310, a second case 320 coupled to the first case 310, and a base 330. The fastening structure 303 may include multiple first magnets 410 disposed in a first protrusion 312 of the first case 310, a second magnet 440 disposed in a second planar portion 331 of the base 330, and a third magnet 430 disposed in a second protrusion 332 of the base 330. The configurations of the first case 310, the second case 320, the base 330, the multiple first magnets 410, the second magnets 440, and the third magnet 430 in FIGS. 11 and 12 may be wholly or partially the same as the configurations of the first case 310, the second case 320, the base 330, the multiple first magnets 410, the multiple second magnets 420, and the third magnet 430 in FIGS. 1 to 9B. The structures of FIGS. 11 and 12 may optionally be combined with the structures of FIGS. 1 to 4B.

According to an embodiment, the multiple first magnets 410 may include six magnets. For example, the multiple first magnets 410 may include a (1-1)^{th} magnet 411, of which the N-pole is oriented in the first direction \textcircled{1}, a (1-2)^{th} magnet 412, of which the N-pole is oriented in the second direction \textcircled{2} and which is in contact with the (1-1)^{th} magnet 411, a (1-3)^{th} magnet 413, of which the N-pole is oriented in the first direction \textcircled{1} and which is in contact with the (1-2)^{th} magnet 412, a (1-4)^{th} magnet 414, of which the N-pole is oriented in the second direction \textcircled{2} and which is in contact with the (1-3)^{th} magnet 413, a (1-5)^{th} magnet 415, of which the N-pole is oriented in the first direction \textcircled{1} and which is in contact with the (1-4)^{th} magnet 414, and a (1-6)^{th} magnet 416, of which the N-pole is oriented in the second direction \textcircled{2} and which is in contact with the (1-5)^{th} magnet 415.

According to an embodiment, the inner portion 320b of the second case 320 may include at least one first groove 325 recessed outward. The first groove 325 may be a space in which a third magnet 430, which will be described in greater detail below, slides by magnetic force. The recessed length of the first groove 325 may be smaller than the length of the third magnet 430 to be described in greater detail below. According to an embodiment, the first groove 325 of the second case 320 may include a (1-1)^{th} groove 325a, a (1-2)^{th} groove 325b formed at a position tilted 120 degrees with respect to the central axis A from the (1-1)^{th} groove 325a, and a (1-3)^{th} groove 325c formed at a position tilted 120 degrees with respect to the central axis A from the (1-2)^{th} groove 325b. The (1-3)^{th} groove 325c may be formed at a position tilted 120 degrees with respect to the central axis A from the (1-1)^{th} groove 325a.

According to an embodiment, the second protrusion 332 of the base 330 may include at least one second groove 335 recessed inward. A third magnet 430 may be disposed inside the second groove 335. The recessed length of the second groove 335 may be substantially the same as the length of the third magnet 430 to be described in greater detail below. According to an embodiment, the second groove 335 may include a (2-1)^{th} groove 335a, a (2-2)^{th} groove 335b formed at a position tilted 120 degrees with respect to the central axis A from the (2-1)^{th} groove 335a, and a (2-3)^{th} groove 335c formed at a position tilted 120 degrees with respect to the central axis A from the (2-2)^{th} groove 335b. The (2-3)^{th} groove 335c may be formed at a position tilted 120 degrees with respect to the central axis A from the (2-1)^{th} groove 335a. According to an embodiment, the second groove 335 may correspond to the first groove 325 of the aforementioned second case 320. When the case and the base 330 are coupled, the case and the base 330 may be coupled such that the second groove 335 and the first groove 325 face each other. For example, the case and the base 330 may be coupled such that the (1-1)^{th} groove 325a of the second case 320 faces the (2-1)^{th} groove 335a of the base 330, the (1-2)^{th} groove 325b of the second case 320 faces the (2-2)^{th} groove 335b of the base 330, and the (1-3)^{th} groove 325c of the second case 320 faces the (2-3)^{th} groove 335b of the base 330.

According to an embodiment, the fastening structure 303 may include multiple second magnets 420 disposed in the second planar portion 331 of the base 330 and a third magnet 430 disposed in the second protrusion 332 of the base 330.

According to an embodiment, the multiple second magnets 420 may include six magnets. For example, the multiple second magnets 420 may include a (2-1)^{th} magnet 421, of which the N-pole is oriented in the first direction \textcircled{1} (e.g., upward), a (2-2)^{th} magnet 422, of which the N-pole is oriented in the second direction \textcircled{2} (e.g., downward) and which is in contact with the (2-1)^{th} magnet 421, a (2-3)^{th} magnet 423, of which the N-pole is oriented in the first direction \textcircled{1} and which is in contact with the (2-2)^{th} magnet 422, a (2-4)^{th} magnet 424, of which the N-pole is oriented in the second direction \textcircled{2} and which is in contact with the (2-3)^{th} magnet 423, a (2-5)^{th} magnet 425, of which the N-pole is oriented in the first direction \textcircled{1} and which is in contact with the (2-4)^{th} magnet 424, and a (2-6)^{th} magnet 426, of which the N-pole is oriented in the second direction \textcircled{2} and which is in contact with the (2-5)^{th} magnet 425.

According to an embodiment, the third magnet 450 may include three magnets provided at 120-degree intervals with respect to the central axis A. For example, the third magnet 450 may include a (3-1)^{th} magnet 451, a (3-2)^{th} magnet 452 provided at a position tilted 120 degrees with respect to the central axis A from the (3-1)^{th} magnet 451, and a (3-3)^{th} magnet 453 provided at a position tilted 120 degrees with respect to the central axis A from the (3-2)^{th} magnet 452.

According to an embodiment, the third magnet 450 may be disposed to horizontally face at least one of the multiple first magnets 410. For example, the third magnet 450 may be disposed to face the (2-1)^{th} magnet 421, the (2-3)^{th} magnet 423, and the (2-5)^{th} magnet 425 among the multiple second magnets 420, of which the N-pole is oriented in the first direction \textcircled{1} (e.g., upward). For example, the third magnet 450 may be disposed to face the (2-2)^{th} magnet 422, the (2-4)^{th} magnet 424, and the (2-6)^{th} magnet 426 among the multiple second magnets 420, of which the N-pole is oriented in the second direction \textcircled{2} (e.g., downward).

According to an embodiment, the third magnet 450 may be arranged with the same polarity as a magnet adjacent thereto among the multiple second magnets 420. For example, when the third magnet 450 is disposed adjacent to the (2-1)^{th} magnet 421, the (2-3)^{th} magnet 423, and the (2-5)^{th} magnet 425, of which the N-pole is oriented in the first direction \textcircled{1} (e.g., upward), the third magnet 450 may also be disposed such that the N-pole thereof is oriented in the first direction \textcircled{1} (e.g., upward). For example, when the third magnet 450 is disposed adjacent to the (2-2)^{th} magnet 422, the (2-4)^{th} magnet 424, and the (2-6)^{th} magnet 426, of which the N-pole is oriented in the second direction \textcircled{2} (e.g., downward), the third magnet 450 may also be disposed such that the N-pole thereof is oriented in the second direction \textcircled{2} (e.g., downward).

By providing the third magnet 450 at a position corresponding to a magnet with the same polarity direction among the multiple second magnets 420, the coupling position and direction of the case and the base 330 may not be limited during the coupling thereof. For example, when no attraction is generated between the multiple first magnets 410 and the multiple second magnets 420, the third magnet 450 may not be aligned with the first groove 321. Thus, the third magnet may not be fixed in position. Simultaneously, a rotational force may be generated in the direction where attraction is generated between the multiple first magnets 410 and the multiple second magnets 420, allowing the third magnet 450 to slide to be positioned inside the first groove 321.

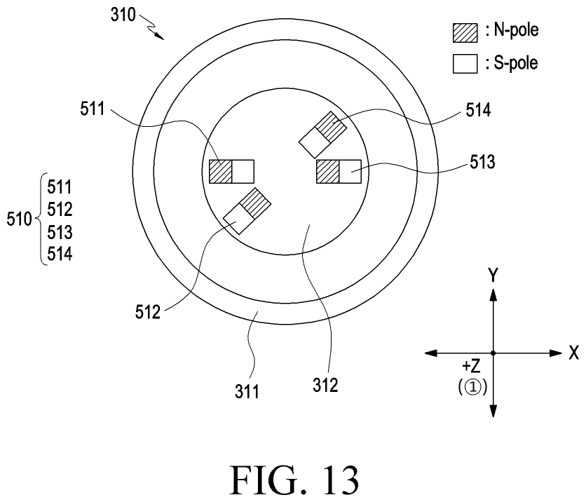

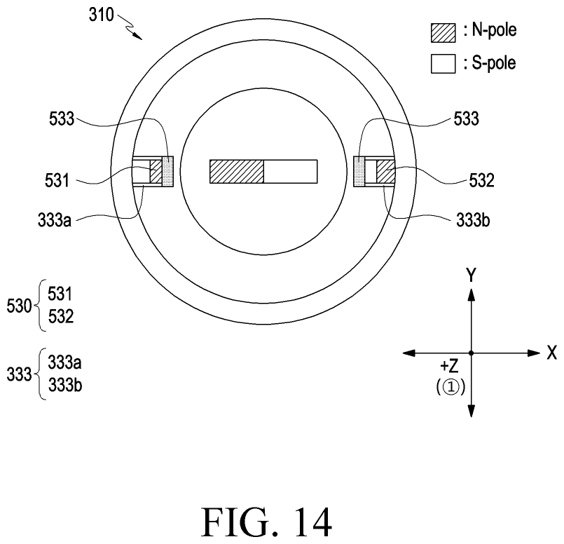

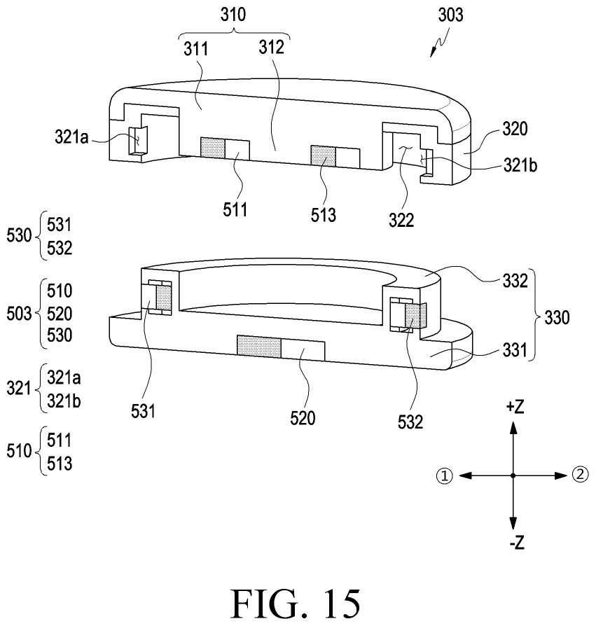

FIG. 13 is a diagram illustrating a top projection view of a first case 310 according to various embodiments. FIG. 14 is a diagram illustrating a top projection view of a base 330 according to various embodiments. FIG. 15 is a cross-sectional perspective view illustrating the pre-coupling state of a fastening structure according to various embodiments.

Referring to FIGS. 13, 14 and 15 (which may be referred to as FIGS. 13 to 15), the fastening structure may include a first case 310, a second case 320 coupled to the first case 310, and a base 330. According to an embodiment, the fastening structure may include multiple first magnets 510 disposed in a first protrusion 312 of the first case 310, a second magnet 520 disposed in a second planar portion 331 of the base 330, and a third magnet 530 disposed in a second protrusion 332 of the base 330. The configurations of the first case 310, the second case 320, the base 330, the multiple first magnets 510, the second magnet 520, and the third magnet 530 in FIGS. 13 to 15 may be wholly or partially the same as the configurations of the first case 310, the second case 320, the base 330, the multiple first magnets 510, the multiple second magnets 520, and the third magnet 530 in FIGS. 1 to 9B. The structures of FIGS. 13 to 15 may optionally be combined with the structures of FIGS. 1 to 9.

According to an embodiment, the fastening structure may include multiple first magnets 510 disposed in the first protrusion 312 of the first case 310.

According to an embodiment, the multiple first magnets 510 may be arranged such that magnets, of which the N-pole is oriented outward, and magnets, of which the N-pole is oriented inward, are alternately disposed. The multiple first magnets 510 may include a (1-1)^{th} magnet 511, of which the N-pole is oriented outward and a (1-2)^{th} magnet 512, of which the N-pole is oriented inward and which is in contact with the (1-1)^{th} magnet 511. In an embodiment of the disclosure, since the S-pole is oriented in a direction opposite to the N-pole, it may be understood in the same manner. For example, when the N-pole of a magnet is oriented outward, the S-pole may be oriented inward. For example, when the N-pole is oriented inward, the S-pole may be oriented outward.

According to an embodiment, the multiple first magnets 510 may include four magnets. For example, the multiple first magnets 510 may include a (1-1)^{th} magnet 511, of which the N-pole is oriented outward, a (1-2)^{th} magnet 512 of which the N-pole is oriented inward and which is tilted at a predetermined angle with respect to the central axis A from the (1-1)^{th} magnet 511, a (1-3)^{th} magnet 513, of which the N-pole is oriented inward and which is disposed horizontally in the opposite direction of the (1-1)^{th} magnet 511 with respect to the central axis A, and a (1-4)^{th} magnet 514, of which the N-pole is oriented outward and which is disposed horizontally in the opposite direction of the (1-2)^{th} magnet 512 with respect to the central axis A. According to an embodiment, the (1-1)^{th} magnet 511 and the (1-3)^{th} magnet 513 may be disposed in opposite positions with respect to the central axis A. The (1-1)^{th} magnet 511 and the (1-3)^{th} magnet 513 may be positioned such that the N-poles thereof are oriented in opposite directions (outward and inward). The (1-2)^{th} magnet 512 and the (1-4)^{th} magnet 514 may be disposed in opposite directions with respect to the central axis A. The (1-2)^{th} magnet 512 and the (1-4)^{th} magnet 514 may be positioned such that the N-poles thereof are oriented in opposite directions (outward and inward). However, the number of multiple first magnets 510 is not limited and may be variously modified depending on the arrangement and structure of surrounding components.

According to an embodiment, the multiple first magnets 510 may be coupled to vertically correspond to the multiple second magnets 520 and may be coupled to horizontally correspond to the third magnet 530. The fastening structure may have a structure that includes magnets coupled in both the horizontal and vertical directions to provide a strong coupling force, and to allow the magnets coupled in the horizontal direction and the magnets coupled in the vertical direction to be simultaneously coupled and uncoupled.

According to an embodiment, the fastening structure may include a second magnet 520 disposed in the second planar portion 331 of the base 330 and a third magnet 530 disposed in the second protrusion 332 of the base 330.

According to an embodiment, the second magnet 520 may vertically correspond to at least some of the multiple first magnets 510. According to an embodiment, the second magnets 520 may have an N-pole oriented in a third direction \textcircled{3} (e.g., leftward) and an S-pole oriented in a fourth direction \textcircled{4} (e.g., rightward) opposite to the third direction \textcircled{3}, with respect to the central axis A. The second magnets 520 may not vertically correspond to portions of the multiple first magnets 510 oriented outward but may vertically correspond to portions oriented inward. For example, the N-pole of the second magnet 520 oriented in the third direction \textcircled{3} may vertically correspond to the S-pole of the (1-1)^{th} magnet 511 oriented inward. For example, the S-pole of the second magnet 520 oriented in the fourth direction \textcircled{4} may vertically correspond to the N-pole of the (1-3)^{th} magnet 513 oriented inward. According to an embodiment, the second magnet 520 may guide the fastening of some of the multiple first magnets 510 to facilitate fastening and provide fastening force itself. For example, attraction between the second magnet 520 and the multiple first magnets 510 may facilitate the coupling of the case and the base 330. For example, repulsion between the second magnet 520 and the multiple first magnets 510 may facilitate the uncoupling of the case and the base 330.

According to an embodiment, the third magnet 530 may be disposed in the second protrusion 332 of the base 330.

According to an embodiment, an inner portion 320b of the third magnet 530 may be arranged with the same polarity as an adjacent portion of the second magnet 520. For example, when the third magnet 530 is disposed adjacent to the third direction \textcircled{3} (e.g., leftward) in which the N-pole of the second magnet 520 is oriented, the N-pole of the third magnet 530 may be disposed to be oriented in the fourth direction \textcircled{4} (e.g., rightward or inward) adjacent to the second magnet 520.

According to an embodiment, the third magnet 530 may include multiple magnets. According to an embodiment, the third magnet 530 may include two magnets. For example, the third magnet 530 may include a (3-1)^{th} magnet 531 and a (3-2)^{th} magnet 532 disposed in opposite directions with respect to the central axis A. For example, the (3-1)^{th} magnet 531 may be disposed adjacent to the N-pole portion of the second magnet 520 oriented in the third direction \textcircled{3} and may be disposed such that the N-pole thereof is oriented in the fourth direction \textcircled{4} (e.g., rightward), differently from the second magnet 520. For example, the (3-2)^{th} magnet 532 may be disposed adjacent to the S-pole portion of the second magnet 520 oriented in the fourth direction \textcircled{4} and may be disposed such that the N-pole thereof is oriented in the fourth direction \textcircled{4} (e.g., rightward), differently from the second magnet 520. In this case, the (3-1)^{th} magnet 531 and the (3-2)^{th} magnet 532 may be positioned such that the N-poles thereof are oriented in the same direction.

According to an embodiment, the third magnet 530 may be positioned on the second protrusion 332 of the base 330, but may neither be coupled to the second protrusion 332 nor fixed in position. The third magnet 530 may be positioned inside the second groove 333 of the second protrusion 332. One surface of the third magnet 530 may be exposed to the outside.

According to an embodiment, the third magnet 530 may slide within the inner space defined by the second groove 333 and/or the first groove 321 due to the attraction and/or repulsion between the third magnet 430 and an adjacent magnet among the multiple first magnets 510. When the third magnet 530 slides from the second groove 333 to the first groove 321, a portion of the third magnet 530 may be positioned in the first groove 321 while another portion of the third magnet 530 remains in the second groove 333, thereby allowing the case and the base 330 to be coupled and/or fixed. When the third magnet 530 slides from the first groove 321 to the second groove 333, the case and the base 330 may be separated.

According to an embodiment, an attachment 533 made of plastic may be coupled to the third magnet 530. The attachment 533 may include a low-friction plastic such as acetal (POM) or polytetrafluoroethylene (PTFE). By coupling the attachment 533 to the third magnet 530, friction may be reduced, enabling smooth sliding motion. The attachment 533 may be coupled to an inner edge of the third magnet 530. The height h1 (the Z-axis direction length) of the second groove 333 may be substantially the same as the height of the third magnet 530. The height h2 (the Z-axis direction length) of the combination of the attachment 533 and the third magnet 530 may be greater than the height of the second groove 333. Accordingly, even if a portion of the third magnet 530 is positioned outside the second groove 333 after sliding from the second groove 333 to the first groove 321, the third magnet 530 may be prevented or inhibited from completely detaching from the second groove 333.

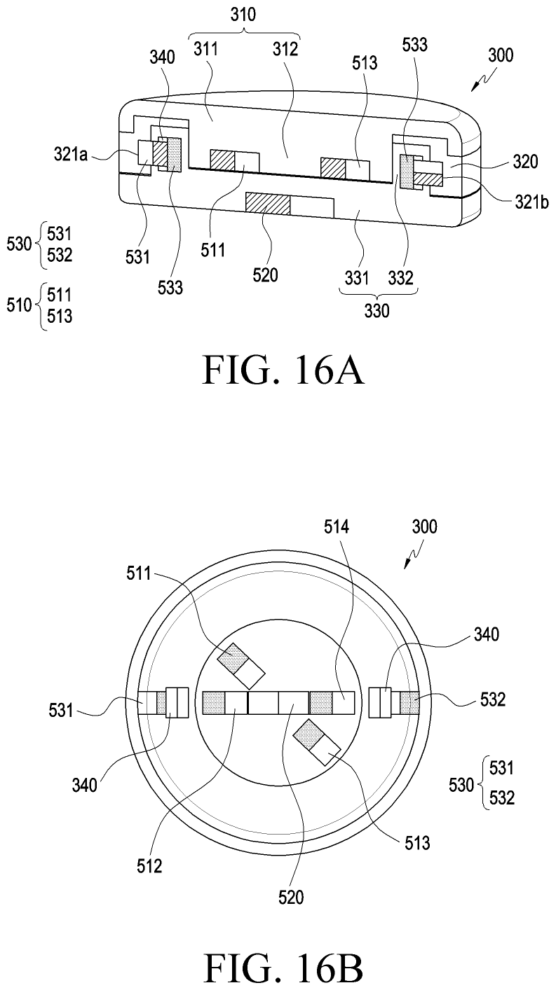

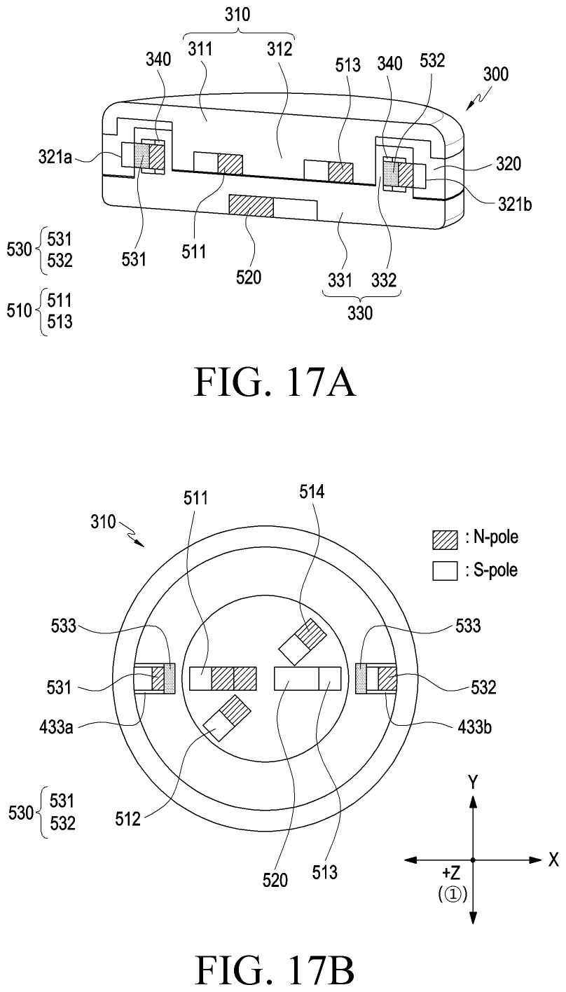

FIGS. 16A and 16B include a cross-sectional perspective view and a diagram illustrating a coupled and fixed state of the fastening structure according to various embodiments. FIGS. 17A and 17B include a cross-sectional perspective view and a diagram illustrating an uncoupled state of the fastening structure according to various embodiments.

Referring to FIGS. 16A, 16B, 17A and 17B (which may be referred to as FIGS. 16A to 17B), the fastening structure may include a first case 310, a second case 320 coupled to the first case 310, and a base 330. According to an embodiment, the fastening structure may include multiple first magnets 510 disposed in a first protrusion 312 of the first case 310, a second magnet 520 disposed in a second planar portion 331 of the base 330, and a third magnet 530 disposed in a second protrusion 332 of the base 330. The configurations of the first case 310, the second case 320, the base 330, the multiple first magnets 510, the second magnet 520, and the third magnet 530 in FIGS. 16A to 17B may be wholly or partially the same as the configurations of the first case 310, the second case 320, the base 330, the multiple first magnets 510, the multiple second magnets 520, and the third magnet 530 in FIGS. 1 to 12. The components of FIGS. 16A to 17B may be selectively combined with the components of FIGS. 1 to 12.

According to an embodiment, an attachment 533 an attachment 533 made of plastic may be coupled to the third magnet 530. The description of the attachment 533 may be equally applied to the attachment 5331 described with reference to FIG. 14.

According to an embodiment, referring to FIGS. 15A and 15B, the process in which the case and the base 330 are coupled and fixed (locked) is described. When the case, in which the first case 310 and the second case 320 are coupled, approaches the base 330, some of the multiple first magnets 510 may be coupled to vertically correspond to a portion of the second magnet 520, and attraction may be generated between some of the multiple first magnets 510 and the second magnet 520. The multiple first magnets 510 may be coupled to horizontally correspond to the third magnet 530, and repulsion may be generated between the multiple first magnets 510 and the third magnet 530. The third magnet 530 may slide from the second groove 333 to the first groove 321 due to the repulsion. Since the recessed length of the first groove 321 is smaller than the length of the third magnet 530, a portion of the third magnet 530 may be disposed inside the first groove 321, while the remaining portion of the third magnet 530 may be disposed inside the second groove 333. The third magnet 530 may be disposed across the first groove 321 formed in the second case 320 and the second groove 333 formed in the base 330, thereby fixing the case and the base 330. For example, the S-pole of the (1-1)^{th} magnet 511, of which the N-pole is oriented in the third direction \textcircled{3} (leftward), may be fastened to vertically correspond to the second magnet 520, of which the N-pole is oriented in the third direction \textcircled{3}. In this case, since attraction is generated between the S-pole of the (1-1)^{th} magnet 511 and the N-pole of the second magnet 520, the fastening of the case and the base 330 may be facilitated. Simultaneously, the (1-1)^{th} magnet 511, of which the N-pole is oriented in the third direction \textcircled{3} (leftward), may be fastened to horizontally correspond to the (3-1)^{th} magnet 531, of which the N-pole is oriented in the fourth direction \textcircled{4} (rightward). In this case, since repulsion is generated between the (1-1)^{th} magnet 511 and the (3-1)^{th} magnet 531, the (1-1)^{th} magnet 511 may slide from the (2-1)^{th} groove 333a toward the (1-1)^{th} groove. Since a portion of the (1-1)^{th} magnet 511 is positioned inside the (1-1)^{th} groove 321a and another portion of the (1-1)^{th} magnet 511 is positioned inside the (2-1)^{th} groove 333a, the coupling of the case and the base 330 may be locked.

According to an embodiment, referring to FIGS. 16A and 16B, the process in which the case and the base 330 are uncoupled (unlocked) is described. A user may rotate the case clockwise or counterclockwise. When the case is rotated by a certain angle, the positions of the multiple first magnets 510 may change, thereby changing the relationship between the multiple first magnets 510 and the multiple second magnets 520, as well as the relationship between the multiple first magnets 510 and the third magnet 530. Some of the repositioned multiple first magnets 510 may be coupled to vertically correspond to some of the second magnets 520, and repulsion may be generated between the multiple first magnets 510 and the second magnets 520. The multiple first magnets 510 may be coupled to horizontally correspond to the third magnet 530, and attraction may be generated between the multiple first magnets 510 and the third magnet 530. The third magnet 530 may slide from the first groove 321 to the second groove 333 due to the repulsion. As the third magnet 530 moves into the second groove 333, the case and the base 330 may be uncoupled (unlocked). For example, when the case is rotated by a predetermined angle (e.g., 60 degrees) in the first rotating direction (e.g., clockwise), the (1-2)^{th} magnet 512 may be positioned where the (1-1)^{th} magnet 511 was previously positioned. The N-pole of the (1-2)^{th} magnet 512 oriented in the fourth direction \textcircled{4} (rightward) may be positioned to vertically correspond to the N-pole of the second magnet 520, which is oriented in the third direction \textcircled{3} (leftward). In this case, since repulsion is generated between the (1-2)^{th} magnet 512 and the second magnet 520, the uncoupling of the case and the base 330 may be facilitated. Simultaneously, the (1-2)^{th} magnet 512, of which the N-pole is oriented in the fourth direction \textcircled{4}, may be positioned to horizontally correspond to the (3-1)^{th} magnet 531, of which the N-pole is oriented in the fourth direction \textcircled{4}. In this case, since attraction is generated between the (1-1)^{th} magnet 511 and the (3-1)^{th} magnet 531, the (1-1)^{th} magnet 511 may slide from the (1-1)^{th} groove 321a toward the (2-1)^{th} groove. After sliding, the (1-1)^{th} magnet 511 may be entirely positioned inside the (2-1)^{th} groove 333a, thereby allowing the case and the base 330 to be uncoupled. The fastening structure using magnets according to an embodiment may change the magnetic force direction through rotational motion, thereby allowing the magnets doubly coupled in the horizontal and vertical directions to be simultaneously uncoupled. When the N-poles and S-poles of magnets are arranged horizontally rather than vertically, the sizes of the magnets may be reduced, making the magnets suitable for compact products.

In general, various types of machines, mechanisms, devices, and equipment include numerous members or components, each of which is tightly coupled through various fastening methods. A fastening structure using magnets primarily functions to align positions and adopts a method of fixing positions by additionally utilizing physical structures such as hooks. The fastening structure using magnets may be easily uncoupled by an external force acting in the direction in which magnetic force is generated.

A fastening structure using magnets according to an embodiment of the disclosure may provide a strong coupling force by arranging magnets simultaneously in both vertical and horizontal directions. Since dual fastening is achievable using only magnets without additional physical structures, the structure may be simplified.

The fastening structure using magnets according to an embodiment of the disclosure may change the magnetic force direction through rotational motion, thereby allowing the magnets doubly coupled in the horizontal and vertical directions to be simultaneously uncoupled.

However, the problems that the disclosure seeks to address are not limited to the aforementioned problems, and may be expanded in various ways without departing from the spirit and scope of the disclosure.

A fastening structure according to an example embodiment of the disclosure may include a first case configured to rotate around a central axis and including a first planar portion and a first protrusion protruding downward from a central area of the first planar portion, a ring-shaped second case configured to allow at least a portion of the first protrusion to pass therethrough and including at least one groove recessed in an inner portion, and a base including a second planar portion, and a second protrusion protruding upward from the second planar portion and corresponding to a first concave portion defined by the first case and the second case. The first protrusion may include multiple first magnets. The second planar portion of the base may include multiple second magnets disposed to vertically correspond to the multiple first magnets. The second protrusion of the base may include a third magnet disposed to horizontally face at least one of the multiple first magnets and horizontally to face the first groove.

According to an example embodiment, the second protrusion of the base may include at least one second groove (e.g., 333 in FIG. 6A) recessed inward, and the third magnet may be positioned at least partially within the second groove.

According to an example embodiment, the third magnet may be configured to slide within a space defined by the first groove and the second groove.

According to an example embodiment, in a first state in which the case and the base are coupled, the multiple first magnets may be configured to generate an attractive force with the multiple second magnets and repulsion with the third magnet.

According to an example embodiment, in the first state, the third magnet is configured to slide from the second groove to the first groove due to the repulsion, and at least an one end is positioned within the first groove and at least the opposite end is positioned within the second groove after the sliding.

According to an example embodiment, in a second state in which the case and the base are separated, the multiple first magnets may be configured to generate a repulsive force with the multiple second magnets and attraction with the third magnet.

According to an example embodiment, in the second state, the third magnet may be configured to at least partially slide from the first groove to the second groove due to the attraction, and to be positioned within the second groove after the sliding.

According to an example embodiment, the multiple first magnets may include a (1-1)^{th} magnet (e.g., 411 in FIG. 4A), of which the N-pole is oriented upward, and a (1-2)^{th} magnet (e.g., 412 in FIG. 4A), of which the N-pole is oriented downward and which is in contact with the (1-1)^{th} magnet.

According to an example embodiment, the multiple second magnets may include a (2-1)^{th} magnet (e.g., 421 in FIG. 6A), of which the N-pole is oriented upward, and a (2-2)^{th} magnet (e.g., 422 in FIG. 6A), of which the N-pole is oriented downward and which is in contact with the (2-1)^{th} magnet.

According to an example embodiment, the third magnet may be disposed adjacent to the (2-1)^{th} magnet and have an N-pole disposed to face upward.

According to an example embodiment, the third magnet may further include an attachment (e.g., 433 in FIG. 6A) including plastic.

According to an example embodiment, a side surface of the second case may include a first guide portion (e.g., 501 in FIG. 10) recessed upward, and a side surface of the base may include a second guide portion (e.g., 502 in FIG. 10) protruding upward and corresponding to the first guide portion.

According to an example embodiment, the third magnet (e.g., 450 in FIG. 11) may include a (3-1)^{th} magnet (e.g., 451 in FIG. 11), a (3-2)^{th} magnet (e.g., 452 in FIG. 11) formed at a position tilted at a predetermined angle relative to the central axis from the (3-1)^{th} magnet, and a (3-3)^{th} magnet (e.g., 453 in FIG. 11) formed at a position tilted at the predetermined angle relative to the central axis from the (3-2)^{th} magnet.

According to an example embodiment, the third magnet may be disposed adjacent to a magnet, of which the N-pole is oriented upward among the multiple second magnets, and the third magnet may be disposed such that the N-pole faces upward.

A fastening structure according to an example embodiment of the disclosure may include a first case configured to rotate around a central axis and including a first planar portion and a first protrusion protruding downward from a central area of the first planar portion, a ring-shaped second case configured to allow at least a portion of the first protrusion to pass therethrough and including at least one groove recessed in an inner portion, and a base including a second planar portion, and a second protrusion protruding upward from the second planar portion and corresponding to a first concave portion defined by the first case and the second case. The first protrusion may include a first magnetic assembly including a (1-1)^{th} magnet having a first pole, and a (1-2)^{th} magnet disposed adjacent to the (1-1)^{th} magnet and having a second pole that is opposite to the first pole. The planar portion of the base may include a second magnetic assembly disposed to vertically correspond to the first magnetic assembly and including a (2-1)^{th} magnet having the first pole and a (2-2)^{th} magnet disposed adjacent to the (2-1)^{th} magnet and having the second pole. The second protrusion of the base may include a third magnet having the first pole and disposed to horizontally face at least one magnet of the first magnetic assembly and to horizontally face the groove.

According to an example embodiment, the second protrusion of the base may include at least one second groove recessed inward, and the third magnet may be positioned at least partially within the second groove.

According to an example embodiment, the third magnet may be configured to slide within a space defined by the first groove and the second groove.

According to an example embodiment, the first direction may be a left direction, and the second direction may be a right direction.

According to an example embodiment, in a first state in which the case and the base are coupled, the multiple first magnets may be coupled to generate an attractive force with the multiple second magnets and repulsion with the third magnet, and in a second state in which the case and the base are separated, the multiple first magnets may be coupled to generate a repulsive force with the multiple second magnets and attraction with the third magnet.

A fastening device according to an example embodiment of the disclosure may include a first body, a second body, and a fastening structure configured to detachably couple the first body and the second body. The fastening structure may include a first case configured to be attached to the first body and to rotate around a central axis, and including a first planar portion and a first protrusion having a central region protruding downward from the first planar portion, a ring-shaped second case configured to allow at least a portion of the first protrusion to pass therethrough and including at least one first groove recessed in an inner portion, and a base configured to be attached to the second body, the base including a second planar portion and a second protrusion protruding upward from the second planar portion, the second protrusion corresponding to a first concave portion defined by the first case and the second case, The first protrusion may include multiple first magnets. The second planar portion of the base may include multiple second magnets disposed to vertically correspond to the multiple first magnets. The second protrusion of the base may include a third magnet disposed to horizontally face at least one magnet among the multiple first magnets and to horizontally face the first groove.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A fastening structure comprising:
a case including a first case configured to rotate about a central axis and including a first planar portion and a first protrusion protruding downward from a central area of the first planar portion, and a second case including at least one first groove recessed in an inner portion and configured to allow at least a portion of the first protrusion to pass therethrough; and
a base including a second planar portion, and a second protrusion protruding upward from the second planar portion and corresponding to a first concave portion formed by the first case and the second case,
wherein the first protrusion is configured to accommodate multiple first magnets,
wherein the second planar portion of the base is configured to accommodate multiple second magnets corresponding to the multiple first magnets in a vertical direction, and
wherein the second protrusion of the base accommodates a third magnet corresponding to at least one of the multiple first magnets in a horizontal direction and correspond to the first groove in the horizontal direction.

2. The fastening structure of claim 1, wherein the second protrusion of the base comprises at least one second groove recessed inward, and
wherein the third magnet is positioned at least partially within the second groove.

3. The fastening structure of claim 2, wherein the third magnet is configured to slide within a space formed by the first groove and the second groove.

4. The fastening structure of claim 2, wherein, in a first state in which the case and the base are coupled, the multiple first magnets are configured to generate an attractive force with the multiple second magnets and a repulsive force with the third magnet.

5. The fastening structure of claim 4, wherein, in the first state, the third magnet is configured to slide from the second groove to the first groove due to the repulsive force, and at least one end of the third magnet is positioned within the first groove and at least an opposite end of the third magnet is positioned within the second groove after the sliding.

6. The fastening structure of claim 2, wherein, in a second state in which the case and the base are separated, the multiple first magnets are configured to generate a repulsive force with the multiple second magnets and an attractive force with the third magnet.

7. The fastening structure of claim 6, wherein, in the second state, the third magnet is configured to at least partially slide from the first groove to the second groove due to the attractive force, and to be positioned within the second groove after the sliding.

8. The fastening structure of claim 1, wherein the multiple first magnets comprise a first first magnet, of which an N-pole is oriented upward, and a second first magnet, of which the N-pole is oriented downward and which is in contact with the first first magnet.

9. The fastening structure of claim 1, wherein the multiple second magnets comprise a first second magnet, of which an N-pole is oriented upward, and a second second magnet, of which the N-pole is oriented downward and which is in contact with the first second magnet.

10. The fastening structure of claim 9, wherein the third magnet, of which the N-pole is oriented upward, is disposed adjacent to the first second magnet.

11. The fastening structure of claim 1, wherein the third magnet further comprises an attachment including plastic.

12. The fastening structure of claim 1, wherein a side surface of the second case comprises a first guide portion recessed upward, and
wherein a side surface of the base comprises a second guide portion protruding upward and corresponding to the first guide portion.

13. The fastening structure of claim 1, wherein the third magnet comprises a first third magnet, a second third magnet formed at a position tilted at a specified angle relative to the central axis from the first third magnet, and a third third magnet formed at a position tilted at the specified angle relative to the central axis from the second third magnet.

14. A fastening structure comprising:
a case including a first case configured to rotate about a central axis and including a first planar portion and a first protrusion protruding downward from a central area of the first planar portion, and a ring-shaped second case configured to allow at least a portion of the first protrusion to pass therethrough and including at least one first groove recessed in an inner portion; and
a base including a second planar portion (331 in FIG. 3, and a second protrusion protruding upward from the second planar portion and corresponding to a first concave portion formed by the first case and the second case,
wherein the first protrusion comprises the multiple first magnets, the multiple first magnets including a first first magnet, of which an N-pole is oriented in a first direction, and a second first magnet, of which the N-pole is oriented in a second direction opposite to the first direction and which is in contact with the first first magnet,
wherein the second planar portion of the base comprises multiple second magnets corresponding to the multiple first magnets in a vertical direction, the multiple second magnets including a first second magnet, of which the N-pole is oriented in the first direction, and
wherein the second protrusion of the base comprises a third magnet corresponding to face at least one magnet among the plurality of first magnets in a horizontal direction and correspond to the first groove in the horizontal direction.

15. A fastening device comprising:
a first body;
a second body; and
a fastening structure configured to detachably couple the first body and the second body,
wherein the fastening structure comprises:
a first case configured to be attached to the first body and to rotate about a central axis, and including a first planar portion and a first protrusion having a central region protruding downward from the first planar portion,
a ring-shaped second case configured to allow at least a portion of the first protrusion to pass therethrough and including at least one first groove recessed in an inner portion, and
a base configured to be attached to the second body, the base including a second planar portion and a second protrusion protruding upward from the second planar portion, the second protrusion corresponding to a first concave portion formed by the first case and the second case,
wherein the first protrusion comprises multiple first magnets,
wherein the second planar portion of the base comprises multiple second magnets corresponding to the multiple first magnets in a vertical direction, and
wherein the second protrusion of the base comprises a third magnet configured to corresponding to at least one magnet among the multiple first magnets in a horizontal direction and to correspond to the first groove in the horizontal direction.

16. A fastening structure comprising:
a case including a first case configured to rotate about a central axis and including a first planar portion and a first protrusion protruding downward from a central area of the first planar portion, and a second case including at least one first groove recessed outward in an inner portion and configured to allow at least a portion of the first protrusion to pass therethrough; and
a base including a second planar portion, and a second protrusion protruding upward from the second planar portion and corresponding to a first concave portion formed by the first case and the second case,
wherein the first protrusion is configured to accommodate multiple first magnets including a first first magnet, of which an N-pole is oriented a first direction, and a second first magnet, of which the N-pole is oriented a second direction and which is in contact with the first first magnet,
wherein the second planar portion of the base is configured to accommodate multiple second magnets including a first second magnet, of which an N-pole is oriented the first direction, and a second second magnet, of which the N-pole is oriented the second direction and which is in contact with the first second magnet, corresponding to the multiple first magnets in a vertical direction, and
wherein the second protrusion of the base accommodates a third magnet corresponding to at least one of the multiple first magnets in a horizontal direction and correspond to the first groove in the horizontal direction.

17. The fastening structure of claim 16, wherein the second protrusion of the base comprises at least one second groove recessed inward, and
wherein the third magnet is positioned at least partially within the second groove.

18. The fastening structure of claim 17, wherein the third magnet is configured to slide within a space formed by the first groove and the second groove.

19. The fastening structure of claim 16, wherein the first direction is leftward direction, and the second direction is rightward direction

20. The fastening structure of claim 16,
wherein, in a first state in which the case and the base are coupled, the multiple first magnets are configured to generate an attractive force with the multiple second magnets and a repulsive force with the third magnet, and
wherein, in a second state in which the case and the base are separated, the multiple first magnets are configured to generate a repulsive force with the multiple second magnets and an attractive force with the third magnet.
